(19) United States
(12) Patent Application Publication
(10) Pub. No.: US 2019/0384696 A1
(43) Pub. Date: Dec. 19, 2019

(54) IN-CONTEXT SIMULATION FOR DIGITAL SIGNAGE CONTENT

(71) Applicant: Adobe Inc., San Jose, CA (US)

(72) Inventor: Alexandre Capt, Landser (FR)

(73) Assignee: Adobe Inc., San Jose, CA (US)

(21) Appl. No.: 16/011,746

(22) Filed: Jun. 19, 2018

(51) Int. Cl. G06F 11/36; G06F 9/455

(52) U.S. Cl. CPC G06F 11/3664; G06F 9/455

(57) ABSTRACT

Techniques are disclosed for simulating the rendering of digital signage content variations that may be shown on a digital signage display device. In some examples, a method may include using a simulation user interface (UI) to access one or more device parameters, triggering a rendering of digital signage content responsive to detecting a change in value of a device parameter, and rendering digital signage content within the digital signage simulation application. The device parameter is one of multiple device parameters that define a simulated state of a digital signage display device. The rendered digital signage content may be based on one or more content rules and the simulated state of the digital signage display device.

### FIELD OF THE DISCLOSURE

This disclosure relates generally to digital signage, and more particularly, to simulation of digital signage prior to delivery to a production environment.

### BACKGROUND

Digital signage is a marketing technique that utilizes display devices to deliver, in real-time, customized digital signage content, such as digital images, videos, animations, web pages, multi-media, text, audio, and the like. Digital signage can be found in public spaces, transportation systems, retail locations, hotels, restaurants, and sides of buildings, to name a few examples, to deliver the digital content. Digital signage can be used in a wide range of applications, such as targeting advertising and promotion, public communication, internal communication, product communication, brand awareness, wayfinding, and influencing customer behavior.

Digital signage systems can deliver digital signage content on digital signage display devices based on rules. The rules may reference digital signage display device parameters, and specify the state or conditions of a digital signage display device under which digital signage content is to be rendered on the digital signage display device. For example, a rule may specify that an advertisement for a baby stroller may be displayed on the digital signage display devices located in the toddler section of a department store. So, in some respects, digital signage is intelligent. Marketers can prepare both digital signage content and rules, to govern the display of such content on digital signage display devices based on the rules. However, it can be difficult to develop and test such rules because the marketer does not necessarily have control over the digital signage display devices. In order to test these rules, the device parameters need to be set to particular values to create the various states and conditions of a digital signage display device to trigger the rendering of digital signage content. For example, a device parameter of a digital signage display device that indicates a current weather condition will not indicate rain unless it is actually raining at or near the location of the digital signage display device. As such, it can be difficult to test particular rules that are of interest to the marketer. Moreover, as the delivery of digital signage content can be quite sophisticated, the rules created (e.g., written) to manage the sophisticated delivery of digital signage content may be complex. Unfortunately, in the case of such complex rules, testing the rendering of the digital signage content based on these complex rules can be even more difficult and, in many instances, even impossible.

### BRIEF DESCRIPTION OF THE DRAWINGS

The accompanying drawings are not intended to be drawn to scale. In the drawings, each identical or nearly identical component that is illustrated in various figures is represented by a like numeral, as will be appreciated when read in context.

FIG. 1 illustrates an example digital signage content rules creation process workflow, in accordance with an embodiment of the present disclosure.

FIG. 2 is a block diagram illustrating an example simulation system for simulating the rendering of digital signage content, in accordance with an embodiment of the present disclosure.

FIG. 3 illustrates an example item of global content, in accordance with an embodiment of the present disclosure.

FIG. 4 illustrates an example item of local content, in accordance with an embodiment of the present disclosure.

FIG. 5 is a flow diagram illustrating an example process for simulating rendering of digital signage content, in accordance with an embodiment of the present disclosure.

FIG. 6 is a block diagram illustrating selected components of an example computing system that may be used to perform any of the techniques as variously described in the present disclosure, according to an embodiment.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

### DETAILED DESCRIPTION

Techniques are disclosed for a client-side framework for simulating the generation and rendering of digital signage content variations that may be shown on a digital signage display device. The framework is configured to provide a realistic simulation (e.g., imitation) of the operation of a digital signage display device that can be used to render digital signage. The simulation is achieved by using the framework to imitate various states (e.g., operating conditions, attributes, characteristics, etc.) of a digital signage display device, and executing content rules to simulate the rendering of digital signage content under such imitated states. In some embodiments, the framework includes a user interface (UI) that provides a capability for manipulating (e.g., setting, controlling, etc.) device parameters for simulating various states of a digital signage display device. For example, the device parameters may include a device location parameter, and the UI enables a user to set the device location parameter to any desired location, such as Boston, to simulate a digital signage display device located at Boston. The user can then execute content rules to simulate the rendering of digital signage content within the framework as if the digital signage content is being rendered on the digital signage display device located in Boston. Note, however, that the digital signage content rendered within the framework is not rendered on the actual digital signage display device, such as the digital signage display device located in Boston, for instance.

In more detail, and in accordance with an embodiment of the present disclosure, a digital signage simulation application implements the client-side framework. The digital signage simulation application is configured to provide for simulating various states of a digital signage display device to facilitate the generation and rendering of digital signage content under such simulated states. In an embodiment, the digital signage simulation application includes a device parameters store, a decision module, a rendering module, and a simulation UI. The device parameters store includes device parameters that describe a digital signage display device. For instance, as will be further described below, the device parameters indicate various attributes of the digital signage display device. Examples of device parameters include a current date parameter, a current time parameter, a current weather condition parameter, a forecasted weather condition parameter, a device location parameter, and a current traffic condition parameter, to name a few examples. The decision module is configured to determine the digital signage content to render based on the values of the device parameters in the device parameters store and the content rules. The rendering module is configured to render the digital signage content as determined by the decision module. For instance, the rendering module can request the decision module to provide the digital signage content, and render the provided digital signage content on a display device. The simulation UI is configured to provide access to the device parameters in the device parameters store for editing (e.g., changing) the device parameters. For instance, the simulation UI allows a user to edit one or more device parameters to simulate a desired state of a digital signage display device. In some embodiments, the simulation UI is configured to trigger a rendering (or re-rendering) of the digital signage content upon detecting a change to a device parameter.

In an example use case and embodiment, the digital signage simulation application is configured to execute on a computing device, such as an authoring device, used by a marketer to create content rules. For example, the marketer can use the authoring device to create content rules for rendering digital signage content on digital signage display devices located at a specific location in New York City. In this example, the marketer and the authoring device may be located at the site of a digital signage display device in New York City or located remotely. Having created or during creation of the content rules, the marketer can execute the digital signage simulation application on the authoring device, and simulate on the authoring device the rendering of digital signage content as if being rendered on the digital signage display device located at the specific location in New York City. The simulated rendering of the digital signage content is based on execution of the created content rules, and allows the marketer to test the created content rules by, for example, previewing the simulated rendering of the digital signage content. Continuing the above example, the simulated rendering of the digital signage content may reveal that execution of the created content rules will erroneously render Japanese text instead of the intended English text on the digital signage display device located at the specific location in New York City. In this case, the marketer can change the created content rules to change the displayed text from Japanese to English.

Additionally or alternatively, the marketer can use the simulation UI to simulate, within the digital signage simulation application, the operation of a digital signage display device in various operating states. For example, one device parameter may allow for specifying a current date, which allows for simulating the operation of the digital signage display device as if the digital signage display device is operating at the specified current date. Another device parameter may allow for specifying a device location, which allows for simulating the operation of the digital signage display device as if the digital signage display device is located at the specified device location. Still another device parameter may allow for specifying a current weather condition, which allows for simulating the operation of the digital signage display device as if the digital signage display device is operating under the specified current weather condition. Continuing the above example, the marketer can use the simulation UI to edit the value of the current date parameter to a future date, for instance, Dec. 24, 2018, to simulate, within the digital signage simulation application, the operation of the digital signage display device located at the specific location in New York City on Dec. 24, 2018. This allows the marketer to preview on the marketing device the digital signage content that will be rendered on the digital signage display device located at the specific location in New York City on Dec. 24, 2018. The marketer can similarly edit the value of the device location parameter to no longer simulate operation of the digital signage display device located at the specific location in New York City. In a more general sense, the simulation UI allows for controlling the simulation of various states of a digital signage display device, which allows for generating and rendering, within the digital signage simulation application, digital signage content under the simulated states of the digital signage display device.

Thus, the foregoing framework provides a digital signage simulation application (or other such application) that provides simulation functionality to simulate various states of a digital signage display device. The simulation of the various states of the digital signage display device provides for testing content rules created to generate and render digital signage content on the digital signage display device. Existing solutions perform any testing of the content rules on the actual digital signage display devices in the production environment. As previously noted, such testing requires control of the actual digital signage display devices that is being used to test the content rules, which impacts and even prohibits the normal operation of the digital signage display devices. The typical result in many cases is that the content rules are not completely or fully tested prior to release in the production environment. In contrast to these existing solutions, the disclosed techniques eliminate the need for impacting actual digital signage display devices, instead allowing the content rules to be tested in a test environment. In general, particular configurations of the framework disclosed herein and the use of such configurations to test the content rules eliminate many of the complications and deficiencies inherent in existing solutions, including use of and impact to actual digital display devices in the production environment. Accordingly, the disclosed techniques significantly improve the ease and efficiency, and lower the cost, of development, testing, and maintenance of content rules for managing the generation and rendering of digital signage content on digital signage display devices. These and other advantages and alternative embodiments will be apparent in light of this disclosure.

As used herein, the term “device parameter” refers, in addition to its plain and ordinary meaning, to a characteristic that can help in defining a device, including a state of the device. In the context of a digital signage display device, device parameters capture information as to the characteristics of the digital signage display device, including various operating states of the digital signage display device. Device parameters can include, but are not limited to, a current day parameter, a current date parameter, a current time parameter, a current weather condition parameter, a forecasted weather condition parameter, a device location parameter, a current traffic condition parameter, and one or more tag parameters that further specify a characteristic of the device. Device parameters can include information obtained by the device from other sources, such as other devices. For example, weather data for the current weather condition parameter and the forecasted weather condition parameter can be provided by a weather service. In another example, sensor data, such as indication of movement in front of the digital signage display device, can be captured and provided by physical sensors located in the proximity of the digital signage display device. Other sensors can provide data that indicates whether someone is touching a handle or a button, and such sensor data can be used for activating the rendering of different digital signage content (e.g., a person grabs a phone on a shelf, and the digital signage display device starts playing the corresponding digital signage content for that phone). Other sensors, such as cameras, can provide images of a person or persons in the vicinity of the digital signage display device. The provided images can be processed to determine information such as gender, age, interests, and other data regarding the persons captured in the image. Such information can be used to determine the state of the digital signage display device (e.g., whether the digital signage display device is being viewed by a male adult), and the digital signage content that should be rendered on the digital signage display device.

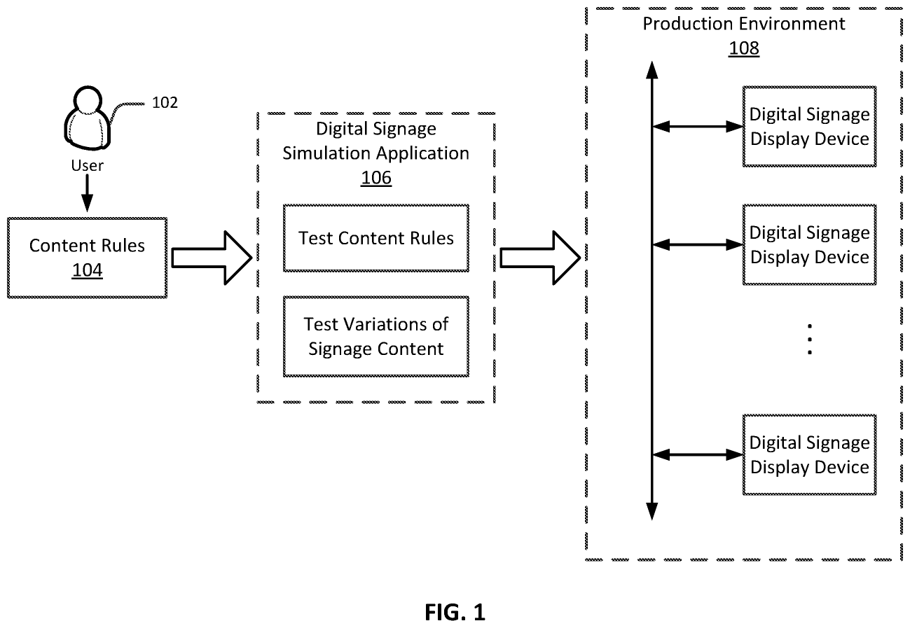

Turning now to the figures, FIG. 1 illustrates an example digital signage content rules creation process workflow, in accordance with an embodiment of the present disclosure. A user 102 may have access to a computing device that facilitates creation of content rules 104. During or subsequent to creating content rules 104, user 102 can start execution of a digital signage simulation application 106 on a computing device that is accessible to user 102. For instance, user 102 can execute digital signage simulation application on a computing device that is local to user 102. As will be discussed in further detail below, digital signage simulation application 106 provides for simulating the operation of a digital signage display device, and executing content rules to simulate the rendering of digital signage content as if content rules are being executed on the actual digital signage display device that is being simulated. User 102 can also use digital signage simulation application 106 to simulate various states of a digital signage display device by, for instance, appropriately setting device parameters for a current date, a current time, a current weather condition, a forecasted weather condition, a device location, and other tags, to name a few examples. The tags may additionally define the digital signage display device and/or further define a device parameter. For example, a tag can identify an entity that “owns” or “controls” the digital signage display device, such as the identity of a department store. As another example, one or more tags can further define the device location by indicating a more specific device location, such as a specific aisle in a specific department store location. A tag can define the marketing purpose of the digital signage display device (e.g., a tag can be used to indicate that digital signage display devices located at the sentry doors to a bank is to render generic digital signage content, while digital signage display devices located at a credit advisor waiting area are to render credit loan digital signage content. A tag can also define business specific criterii, such as whether to render a menu board or a cashier digital signage content at a restaurant. In a general sense, one or more tags can be used to further categorize and/or identify the digital signage display device. As such, user 102 can edit the device parameters to simulate various states of a digital signage display device to test variations of the digital signage content rendered under such states.

In general, user 102 can use simulation module 106 to simulate the operation of a specific digital signage display device or a specific group of digital signage display devices, including simulation of various states (e.g., attributes, characteristics, etc.) of the digital signage display device, by appropriately setting one or more device parameters. Accordingly, digital signage simulation application 106 allows user 102 to test content rules 104 by previewing the digital signage content variations that will be rendered on a particular digital signage display device as a result of execution of content rules 104. For instance, user 102 can detect errors in the operation of content rules 104 by previewing the digital signage contents being rendered on the local computing device on which digital signage simulation application 106 is executing. If an error is detected, user 102 can make appropriate corrections to content rules 104, and retest the corrected content rules. After content rules 104 have been satisfactorily tested, user 102 can release content rules 104 into a production environment 108, which may include one or more digital signage display devices. Thus, the disclosed techniques provide the creator of the content rules full confidence that the digital signage contents being rendered on the actual digital signage display devices as a result of execution of the content rules are the digital signage that is expected by the content rules creator.

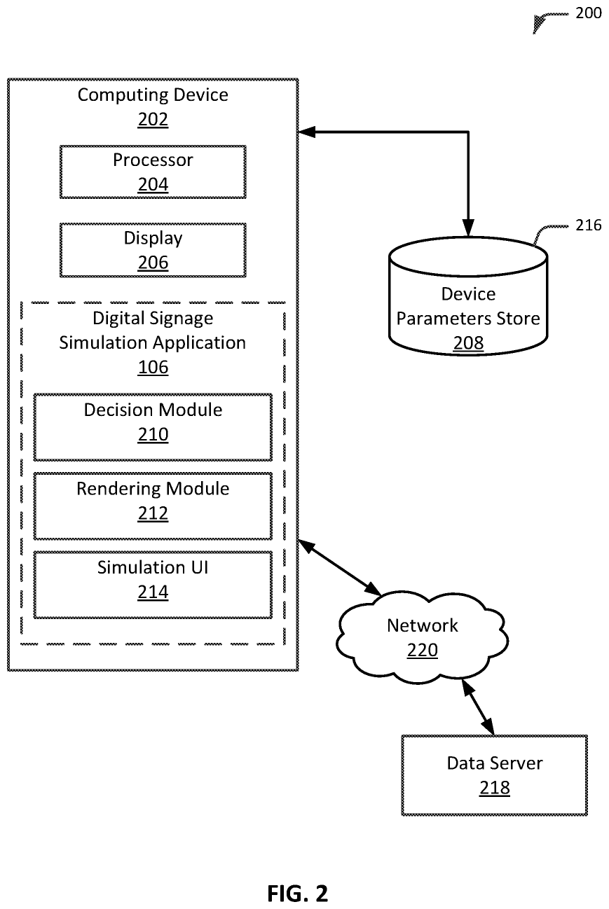

FIG. 2 is a block diagram illustrating an example simulation system 200 for simulating the rendering of digital signage content, in accordance with an embodiment of the present disclosure. System 200 includes a computing device 202, which includes a processor 204, a display 206, and digital signage simulation application 106. Computing device 202 is configured to execute digital signage simulation application 106, which includes a decision module 210, a rendering module 212, and a simulation UI 214. In some embodiments, computing device 202 is a content authoring device used, for instance, by a marketer to create content rules for rendering digital signage contents. In other embodiments, computing device 202 may be any suitable computing device that is accessible to the marketer or other appropriate user and that facilitates execution of digital signage simulation application 106. Computing device 202 is further configured to interact with a device parameters store 208 to access (e.g., read and/or write, etc.) the contents, such as device parameters, of device parameters store 208. In an example embodiment, device parameters store 208 can be stored or otherwise maintained in a data storage 216, which may include a database or other suitable data storage device. In some embodiments, data storage 216 can be implemented on a back-end server that is remote from computing device 202 and operable to communicate with computing device 202 over a network, such as the Internet or an intranet. Data storage 216 can include any suitable digital storage device configured to store digitally encoded data. In some embodiments, data storage 216 includes the digital signage content and the digital signage content rules, such as content rules 104, which may be created using computing device 202.

In some cases, simulation system 200 also includes a data server 218 coupled to computing device 202 via a network 220. Network 220 can be a local area network, a wide area network, the Internet, and/or other wired or wireless networks. Data server 218 can be a server or other computing device that provides various services, including the providing of data, to clients, such as computing device 202. For instance, as will be described in further detail below, data server 218 can provide data, such as values for certain device parameters, to facilitate the simulation of the generation and rendering of digital signage content variations on computing device 202. However, it will be understood that some embodiments can be implemented without data server 218 or network 220 (e.g., implemented entirely on computing device 202).

In various embodiments, additional components (not illustrated, such as a user input device, non-transitory memory, etc.) or a subset of the illustrated components can be employed without deviating from the scope of the present disclosure. For instance, other embodiments may integrate the various functionalities of decision module 210, rendering module 212, and simulation UI 214 into fewer modules (e.g., one or two) or additional modules (e.g., four or five, or more). In addition, further note that the various components of computing device 202 may all be in a stand-alone computing system according to some embodiments, while in others, may be distributed across multiple machines. For example, according to an embodiment, various functionalities of decision module 210, rendering module 212, and simulation UI 214 may be provided in a computing system distinct from computing device 202. In a more general sense, the degree of integration and distribution of the functional component(s) provided herein can vary greatly from one embodiment to the next, as will be appreciated in light of this disclosure.

Digital signage simulation application 106 is configured to generally provide the overall control of the simulation of the operation of a digital signage display device utilizing the services and functionality of decision module 210, rendering module 212, simulation UI 214, device parameters store 208, and other modules and components as necessary. Digital signage simulation application 106 is also configured to provide the overall control of execution of content rules to generate simulated renderings of digital signage content variations under such simulated digital signage display device conditions. For instance, according to some embodiments, digital signage simulation application 106 provides a user the ability to simulate operation of a digital signage display device in various states of operation, and execute content rules configured to render digital signage to simulate the rendering of digital signage under such operating states and based on the content rules. As previously described, the user can execute digital signage simulation application 106 and perform the simulated rendering of the digital signage variations on a computing device other than the actual digital signage display devices (e.g., digital signage display device in the production environment).

Device parameters store 208 is configured to store the device parameters that define or specify a simulated state, such as a current state, of a digital signage display device being simulated by digital signage simulation application 106. The set of device parameters include a current date parameter, a current time parameter, a current weather condition parameter, a forecasted weather condition parameter, a device location parameter, and other tag parameters. For example, the device location parameter can be set to a value “New York City” to simulate operation of a digital signage display device located in New York City. Additionally, a first tag parameter can be set to a value “Macy's” and a second tag parameter can be set to a value “Female Aisle” to simulate operation of a digital signage display device located in the Female Aisle in Macy's department store in New York City. Subsequently, the value of the second tag parameter can be changed to “Children Aisle” to simulate operation of a digital signage display device located in the Children Aisle in Macy's department store in New York City.

In some embodiments, values for one or more device parameters can be provided by data server 218. For instance, data server 218 may be a weather server that provides weather services including weather forecast information. In such embodiments, the values for the current weather condition parameter and/or forecasted weather condition parameter can be periodically retrieved from or provided by data server 218. In the case of a weather server, data server 218 can provide the current weather condition and/or the forecasted weather condition at the location of the digital signage display device being simulated by digital signage simulation application 106. While only one data server 218 is depicted in FIG. 2 for purposes of clarity, it will be appreciated that other embodiments can include additional data servers. For example, another data server can be a traffic server that provides traffic condition information at the location of the digital signage display device being simulated by digital signage simulation application 106.

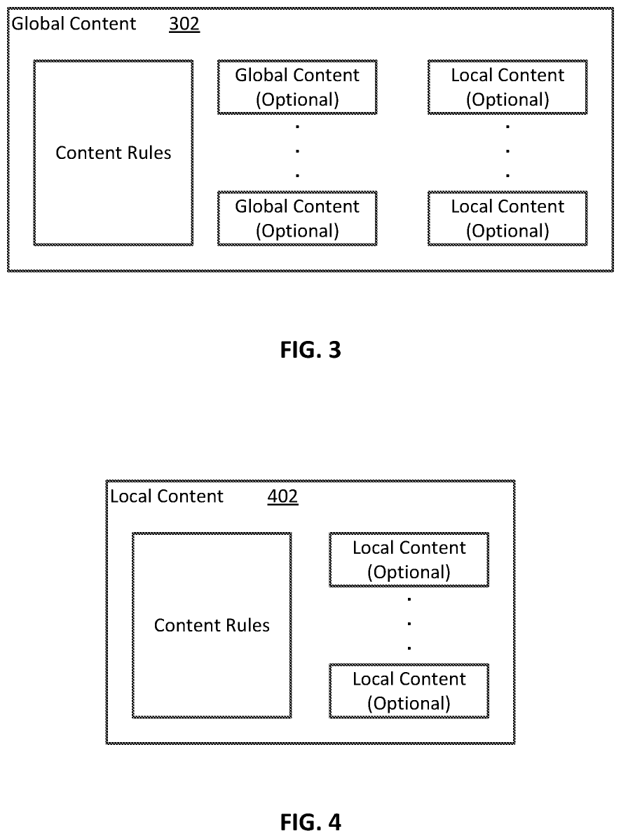

Decision module 210 is configured to determine the digital signage content or contents to render based on the content rules and the values of the device parameters in device parameter store 208. Decision module 210 is provided or otherwise has knowledge of content rules 104. For instance, according to some embodiments, each item of digital signage content is associated with a set of content rules. As will be further described below with reference to FIGS. 3 and 4, the set of content rules associated with an item of digital signage content specify the events or triggers (e.g., conditions) that cause the rendering of the item of digital signage content. In some such embodiments, decision module 210 validates content rules 104 associated with an item of digital signage content against the current values of the device parameters in device parameters store 210 to determine whether the item of digital signage content is to be rendered. Decision module 210 is further described below with reference to FIGS. 3 and 4.

In some embodiments, a server-side rule resolution module (not depicted) can determine the digital signage content or contents to render based on the content rules and the values of the device parameters in device parameter store 208. For instance, the server-side rule resolution module can have knowledge of the content rules for triggering the rendering of the digital signage content items. In some such embodiments, decision module 210 provides or otherwise make available the device parameters (e.g., the values for the device parameters) to the server-side rule resolution module. The server-side rule resolution module can then determine the digital signage content to render by validating the content rules against the provided device parameters. Decision module 210 can, for example, utilize the services of the server-side rule resolution engine in instances where the validation of the content rules is computationally expensive for the digital signage display device being simulated by digital signage simulation application 106. Note that off-loading the content rules validation to the server-side rule resolution module can provide a realistic simulation of the operation of a digital signage display device, in some instances.

Rendering module 212 is configured to provide the sequencing and rendering of digital signage within digital signage simulation application 106. In an example embodiment, rendering module 212 is implemented as a browser application, such as a webview, that controls the rendering of the digital signage content in a browser. In some such embodiments, when rendering module 212 determines that digital signage needs to be rendered, rendering module 212 requests decision module 210 for the digital signage contents and render the digital signage content items provided or otherwise made available by decision module 210. In some embodiments, rendering module 212 renders the digital signage content items on a suitable display device.

Simulation UI 214 is configured to provide an interface with which to interact with the device parameters in device parameters store 208. According to an embodiment, simulation UI 214 is a graphical user interface configured to provide access to the device parameters. For instance, a user can use simulation UI 214 to edit (e.g., update, revise, etc.) the values of one or more device parameters in device parameters store 208. According to some embodiments, simulation UI 214 is configured to trigger a rendering of the digital signage contents upon detecting a change to a device parameter. In some such embodiments, when simulation UI 214 determines that a change is made to a device parameter simulation UI 214 requests rendering module 212 to render digital signage within digital signage simulation application 106.

FIG. 3 illustrates an example item of global content 302, in accordance with an embodiment of the present disclosure. Examples of global content 302 include images, video clips, plugins, code snippets, and/or any other data that may be rendered on a digital signage display device. In brief, global content 302 can be an item of digital signage that is “global” in scope in that global content 302 is general and not specific to the location of any one or more digital signage display devices. As such, global contents are generally for display or rendering on a multiple number of digital signage display devices regardless of the specific location of the digital signage display devices. In more detail and as illustrated, global content 302 includes one or more content rules. The content rules associated with global content 302 specify the events that need to be satisfied for global content 302 to be rendered. For example, in the case global content 302 is a video clip that is to be rendered by digital content display devices on Fridays, a content rule “Current Day=Friday” may be associated with global content 302. Decision module 210 can validate such a content rule against the device parameters to determine whether global content 302 is to be rendered. For example, if a value of a device parameter, such as a current date device parameter or a current day device parameter, indicates that the current day is Friday, decision module 210 can determine that global content 302 is to be rendered. Furthering the example above, global content 302 can be a video clip that is to be rendered by digital content display devices on raining Fridays. As such, a second content rule “Current Weather=Rain” may also be associated with global content 302. Decision module 210 can validate both content rules (e.g., “Current Day=Friday” and “Current Weather=Rain”) against the device parameters to determine whether global content 302 is to be rendered. It will be appreciated that additional content rules may be associated with global content 302.

According to an embodiment, decision module 210 determines that global content 302 is to be rendered upon validating all the content rules associated with global content 302. For instance, in the case global content 302 is associated with three content rules, all three content rules need to be validated for global content 302 to be rendered. In other embodiments, decision module 210 determines that global content 302 is to be rendered upon validating at least one content rule associated with global content 302. For instance, in the case global content 302 is associated with two content rules, at least one of the content rules (e.g., one or both content rules) associated with global content 302 need to be validated for global content 302 to be rendered.

As illustrated in FIG. 3, global content 302 may optionally include references other global content items and/or other local content items. The referenced items of global content and/or local content can be rendered with or as part of global content 302. In some embodiments, the rendering of the referenced items of global content and/or local content can be based on validation of one or more content rules other than the content rules associated with global content 302.

FIG. 4 illustrates an example item of local content 402, in accordance with an embodiment of the present disclosure. Similar to global content 302, examples of local content 402 include images, video clips, plugins, code snippets, and/or any other data that may be rendered on a digital signage display device. In brief, local content 402 can be an item of digital signage that is “local” in scope in that local content 402 is specific to the location of digital signage display devices. As such, local contents are generally for display or rendering on one or more digital signage display devices based on the specific location of the digital signage display devices. In more detail and as illustrated, local content 402 includes one or more content rules. Similar to the content rules associated with an item of global content, the content rules associated with local content 402 specify the events that need to be satisfied for local content 402 to be rendered. For example, in the case local content 402 is a sequence of images that is to be rendered by digital content display devices located in New York City, a content rule “Device Location=New York City” may be associated with local content 402. Decision module 210 can validate such a content rule against the device parameters to determine whether local content 402 is to be rendered. For example, if a value of a device parameter, such as a device location parameter, indicates that the device location is New York City, decision module 210 can determine that local content 402 is to be rendered. Furthering the example above, local content 402 can be a sequence of images that is to be rendered by digital content display devices in the department stores located in New York City and in the Men's aisle of the department stores. As such, a second content rule “Aisle=Male” may also be associated with local content 402. The second content rule “Aisle=Male” can be a value, “Male”, assigned to a parameter tag, “Aisle”. Decision module 210 can validate both content rules (e.g., “Device Location=New York City” and “Aisle=Male”) against the device parameters to determine whether local content 402 is to be rendered. It will be appreciated that additional content rules may be associated with local content 402.

Similar to the processing of global content, in some embodiments, decision module 210 determines that local content 402 is to be rendered upon validating all the content rules associated with local content 402. For instance, in the case local content 402 is associated with four content rules, all four content rules need to be validated for local content 402 to be rendered. In other embodiments, decision module 210 determines that local content 402 is to be rendered upon validating at least one content rule associated with local content 402. For instance, in the case local content 402 is associated with three content rules, at least one of the three content rules (e.g., one, two, or all three content rules) associated with local content 402 need to be validated for local content 402 to be rendered.

As illustrated in FIG. 4, local content 402 can optionally include references other local content items. The referenced items of local content can be rendered with or as part of local content 402. In some embodiments, the rendering of the referenced items of local content can be based on validation of one or more content rules other than the content rules associated with local content 402.

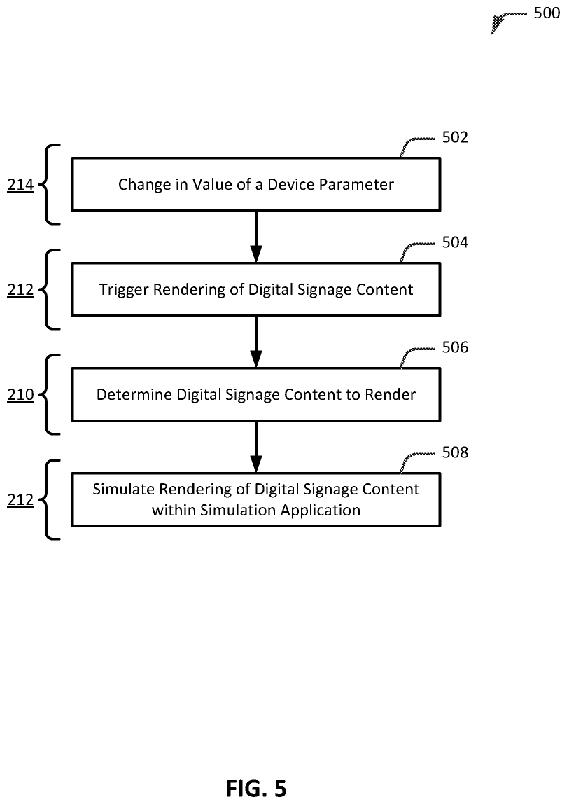

FIG. 5 is a flow diagram illustrating an example process 500 for simulating rendering of digital signage content, in accordance with an embodiment of the present disclosure. The operations, functions, or actions illustrated in example process 500 may in some embodiments be performed by simulation system 200 and, more particularly, digital signage simulation application 106 of computing device 202 of FIG. 2. The operations, functions, or actions described in the respective blocks of example process 500 may also be stored as computer-executable instructions in a non-transitory computer-readable medium, such as a memory and/or a data storage of a computing system. In some instances, process 500 may be performed by components of computing device 202. Further note that the various operations depicted in process 500 do not need to be assigned to the specific example modules shown.

As will be further appreciated in light of this disclosure, for this and other processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments. To this end, process 500 is provided to give one example embodiment and is not intended to limit the methodology to any particular physical or structural configuration.

With reference to process 500, at block 502, a change in a value of a device parameter is detected. By way of example, a user can be using computing device 202 and, specifically, digital signage simulation application 106 executing on computing device 202 to test content rules prior to releasing to a production environment. In this example, in order to preview renderings of digital signage content variations that will be rendered by execution of the content rules, the user can use simulation UI 214 to edit a device parameter. The user can use simulation UI 214 to change the values of one or more device parameters to simulate various states of a digital signage display device. For example, to simulate operation of a digital signage display device located in San Francisco on a Friday, the user can edit the value of the device location parameter to “San Francisco” and the value of the current day parameter to “Friday”.

At block 504, the rendering of digital signage content based on the values of the device parameters and execution of the content rules is triggered. In some embodiments, a change to a device parameter triggers the rendering of digital signage content. In an example implementation, simulation UI 214 requests rendering module 212 to render digital signage within digital signage simulation application 106. Rendering module 212 can then request decision module 210 for the digital signage content to render.

At block 506, the digital signage to render within digital signage simulation application 106 is determined. In the example implementation above, decision module 210 can have knowledge of the content rules associated with each item of digital signage content, and determine the digital signage to render based on a validation of the content rules and the device parameters.

At block 508, the rendering of the digital signage content is simulated within digital signage simulation application 106. In the example implementation above, decision module 210 determines the digital signage content to render and provide or otherwise make available the determined digital signage content to rendering module 212. Rendering module 212 can then render the provided digital signage content. Process 500 may be repeated as needed to manipulate the values of the device parameters to simulate various execution states of a digital signage display device and render digital signage content variations under such simulated states of the digital signage display device.

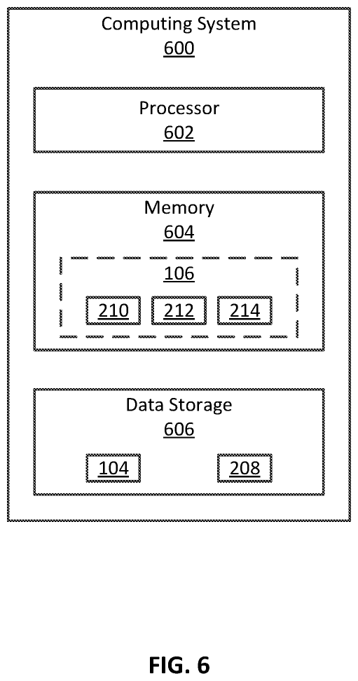

FIG. 6 is a block diagram illustrating selected components of an example computing system 600 that may be used to perform any of the techniques as variously described in the present disclosure, according to an embodiment. In some embodiments, computing system 600 may be configured to implement or direct one or more operations associated with some or all of the engines, components and/or modules associated with simulation system 200 of FIG. 2. For example, digital signage simulation application 106, including decision module 210, rendering module 212, and simulation UI 214, or any combination of these may be implemented in and/or using computing system 600. In one example case, for instance, each of decision module 210, rendering module 212, and simulation UI 214 is loaded in a memory 604 and executable by a processor 602, and content rules 104 and device parameters store 216 are included in a data storage 606. Computing system 600 may be any computer system, such as a workstation, desktop computer, server, laptop, handheld computer, tablet computer (e.g., the iPad® tablet computer), mobile computing or communication device (e.g., the iPhone® mobile communication device, the Android™ mobile communication device, and the like), or other form of computing or telecommunications device that is capable of communication and that has sufficient processor power and memory capacity to perform the operations described in this disclosure. A distributed computational system may be provided that includes a multiple of such computing devices. As depicted, computing system 600 may include processor 602, memory 604, and data storage 606. Processor 602, memory 604, and data storage 606 may be communicatively coupled.

In general, processor 602 may include any suitable special-purpose or general-purpose computer, computing entity, or computing or processing device including various computer hardware, firmware, or software modules, and may be configured to execute instructions, such as program instructions, stored on any applicable computer-readable storage media. For example, processor 602 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 6, processor 602 may include any number of processors and/or processor cores configured to, individually or collectively, perform or direct performance of any number of operations described in the present disclosure. Additionally, one or more of the processors may be present on one or more different electronic devices, such as different servers.

In some embodiments, processor 602 may be configured to interpret and/or execute program instructions and/or process data stored in memory 604, data storage 606, or memory 604 and data storage 606. In some embodiments, processor 602 may fetch program instructions from data storage 606 and load the program instructions in memory 604. After the program instructions are loaded into memory 604, processor 602 may execute the program instructions.

For example, in some embodiments, any one or more of the engines, components and/or modules of simulation system 200 may be included in data storage 606 as program instructions. Processor 602 may fetch some or all of the program instructions from data storage 606 and may load the fetched program instructions in memory 604. Subsequent to loading the program instructions into memory 604, processor 602 may execute the program instructions such that the computing system may implement the operations as directed by the instructions.

In some embodiments, virtualization may be employed in computing device 600 so that infrastructure and resources in computing device 600 may be shared dynamically. For example, a virtual machine may be provided to handle a process running on multiple processors so that the process appears to be using only one computing resource rather than multiple computing resources. Multiple virtual machines may also be used with one processor.

Memory 604 and data storage 606 may include computer-readable storage media for carrying or having computer-executable instructions or data structures stored thereon. Such computer-readable storage media may include any available media that may be accessed by a general-purpose or special-purpose computer, such as processor 602. By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 602 to perform a certain operation or group of operations.

Modifications, additions, or omissions may be made to computing system 600 without departing from the scope of the present disclosure. For example, in some embodiments, computing system 600 may include any number of other components that may not be explicitly illustrated or described herein.

As indicated above, the embodiments described in the present disclosure may include the use of a special purpose or a general purpose computer (e.g., processor 602 of FIG. 6) including various computer hardware or software modules, as discussed in greater detail herein. As will be appreciated, once a general purpose computer is programmed or otherwise configured to carry out functionality according to an embodiment of the present disclosure, that general purpose computer becomes a special purpose computer. Further, as indicated above, embodiments described in the present disclosure may be implemented using computer-readable media (e.g., memory 604 of FIG. 6) for carrying or having computer-executable instructions or data structures stored thereon.

Numerous example variations and configurations will be apparent in light of this disclosure. According to some examples, computer-implemented methods to simulate rendering of digital signage content variations within a digital signage simulation application are described. An example computer-implemented method may include: accessing, via a simulation UI, one or more device parameters; responsive to detecting a change in value of a device parameter, determining digital signage content to render based on one or more content rules and a simulated state of a digital signage display device; and rendering the determined digital signage content within the digital signage simulation application.

In some examples, the change in value of the device parameter is detected by the simulation UI. In other examples, the change in value of the device parameter changes the simulated state of the digital signage display device from a first simulated state to a second simulated state. In still other examples, a content rule of the one or more content rules is associated with an item of global content. In yet other examples, a content rule of the one or more content rules is associated with an item of local content. In further examples, the change in value of the device parameter is provided by a remote data server. In still further examples, the device parameter is one of multiple device parameters, and wherein determining digital signage content to render based on one or more content rules and the simulated state of the digital signage display device includes validating the one or more content rules against the multiple device parameters. In yet further examples, rendering the determined digital signage content is on a display device other than a digital signage display device.

According to some examples, computer program products including one or more non-transitory machine-readable mediums encoded with instructions that when executed by one or more processors cause a process to be carried out to simulate rendering of digital signage content variations within a digital signage simulation application are described. An example process may include: interacting with, using a simulation UI, one or more device parameters; responsive to detecting a change in value of a device parameter, triggering, by the simulation UI, a rendering of digital signage content, wherein the device parameter is one of multiple device parameters; determining, by a decision module, digital signage content to render based on one or more content rules and the multiple device parameters; and rendering, by a rendering module, the determined digital signage content within the digital signage simulation application.

In some examples, the multiple device parameters define a simulated state of a digital signage display device. In other examples, triggering the rendering of digital signage content includes requesting, by the simulation UI, the rendering module to render digital signage within digital signage simulation application. In still other examples, the process may also include requesting, by the rendering module, the decision module to determine the digital signage content to render. In yet other examples, determining digital signage content to render based on one or more content rules and the multiple device parameters includes, validating the one or more content rules against the multiple device parameters. In further examples, the change in value of the device parameter changes the simulated state of the digital signage display device from a first simulated state to a second simulated state. In still further examples, the rendered digital signage content includes an item of global content. In yet further examples, the rendered digital signage content includes an item of local content. In other examples, rendering the determined digital signage content is on a display device other than a digital signage display device.

According to some examples, systems to simulate rendering of digital signage content variations within a digital signage simulation application are described. An example system may include one or more non-transitory machine-readable mediums configured to store instructions; and one or more processors configured to execute the instructions stored on the one or more non-transitory machine-readable mediums. Execution of the instructions by the one or more processors may cause the one or more processors to: simulating, using a simulation UI, operation of a digital signage display device within the digital signage simulation application; responsive to detection of a change in value of a device parameter, trigger a rendering of digital signage content, wherein the device parameter is one of multiple device parameters; determine digital signage content to render based on a validation of the one or more content rules against the multiple device parameters; and render the determined digital signage content within the digital signage simulation application.

In some examples, the determined digital signage content rendered includes at least one of an item of local content and an item of global content. In other examples, the determined digital signage content is rendered on a display device other than a digital signage display device.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the systems and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A computer-implemented method to simulate rendering of digital signage content variations within a digital signage simulation application, the method comprising:
accessing, via a simulation UI, one or more device parameters;
responsive to detecting a change in value of a device parameter, determining digital signage content to render based on one or more content rules and a simulated state of a digital signage display device; and
rendering the determined digital signage content within the digital signage simulation application.

2. The method of claim 1, wherein the change in value of the device parameter is detected by the simulation UI.

3. The method of claim 1, wherein the change in value of the device parameter changes the simulated state of the digital signage display device from a first simulated state to a second simulated state.

4. The method of claim 1, wherein a content rule of the one or more content rules is associated with an item of global content.

5. The method of claim 1, wherein a content rule of the one or more content rules is associated with an item of local content.

6. The method of claim 1, wherein the change in value of the device parameter is provided by a remote data server.

7. The method of claim 1, wherein the device parameter is one of a plurality of device parameters, and wherein determining digital signage content to render based on one or more content rules and the simulated state of the digital signage display device includes:
validating the one or more content rules against the plurality of device parameters.

8. The method of claim 1, wherein rendering the determined digital signage content is on a display device other than a digital signage display device.

9. A computer program product including one or more non-transitory machine-readable mediums encoded with instruction that when executed by one or more processors cause a process to be carried out to simulate rendering of digital signage content variations within a digital signage simulation application, the process comprising:
interacting with, using a simulation UI, one or more device parameters;
responsive to detecting a change in value of a device parameter, triggering, by the simulation UI, a rendering of digital signage content, wherein the device parameter is one of a plurality of device parameters;
determining, by a decision module, digital signage content to render based on one or more content rules and the plurality of device parameters; and
rendering, by a rendering module, the determined digital signage content within the digital signage simulation application.

10. The computer program product of claim 9, wherein the plurality of device parameters defines a simulated state of a digital signage display device.

11. The computer program product of claim 9, wherein triggering the rendering of digital signage content includes requesting, by the simulation UI, the rendering module to render digital signage within digital signage simulation application.

12. The computer program product of claim 11, further comprising requesting, by the rendering module, the decision module to determine the digital signage content to render.

13. The computer program product of claim 9, wherein determining digital signage content to render based on one or more content rules and the plurality of device parameters includes, validating the one or more content rules against the plurality of device parameters.

14. The computer program product of claim 9, wherein the change in value of the device parameter changes the simulated state of the digital signage display device from a first simulated state to a second simulated state.

15. The computer program product of claim 9, wherein the rendered digital signage content includes an item of global content.

16. The computer program product of claim 9, wherein the rendered digital signage content includes an item of local content.

17. The computer program product of claim 9, wherein rendering the determined digital signage content is on a display device other than a digital signage display device.

18. A system to simulate rendering of digital signage content variations within a digital signage simulation application, the system comprising:
one or more non-transitory machine-readable mediums configured to store instructions; and
one or more processors configured to execute the instructions stored on the one or more non-transitory machine-readable mediums, wherein execution of the instructions causes the one or more processors to
simulating, using a simulation UI, operation of a digital signage display device within the digital signage simulation application;
responsive to detection of a change in value of a device parameter, trigger a rendering of digital signage content, wherein the device parameter is one of a plurality of device parameters;
determine digital signage content to render based on a validation of the one or more content rules against the plurality of device parameters; and
render the determined digital signage content within the digital signage simulation application.

19. The system of claim 18, wherein the determined digital signage content rendered includes at least one of an item of local content and an item of global content.

20. The system of claim 18, wherein the determined digital signage content is rendered on a display device other than a digital signage display device.
